(19) United States
(12) Patent Application Publication
(10) Pub. No.: US 2013/0177372 A1
(43) Pub. Date: Jul. 11, 2013

(54) GRAIN BAG EXTRACTOR WITH STEERING AND DRIVE

(71) Applicant: Hubertus de Koning, Neepawa (CA)

(72) Inventor: Hubertus de Koning, Neepawa (CA)

(21) Appl. No.: 13/368,988

(22) Filed: Feb. 8, 2012

(30) Foreign Application Priority Data
Jan. 11, 2012 (CA) 2763876

(51) Int. Cl. B65G 1/00

(52) U.S. Cl. 414/326; 414/808

(57) ABSTRACT

A grain bag extractor has a frame, with a main auger oriented to discharge grain into a transport vehicle, and feed augers extending laterally from the intake end of the main auger to bring in grain from the sides of the bag. Wheels support the apparatus, a wheel drive rotates the wheels, and a drive control activates the wheel drive. A steering actuator steers the wheels. The drive and steering controls are placed so that an operator can view the bag and feed augers, and control the speed of wheel rotation, and steer the apparatus into the bag.

This invention is in the field of agricultural equipment and in particular an apparatus for removing grain from a large plastic bag.

### CROSS-REFERENCE TO RELATED APPLICATIONS

This application claims priority to Canadian Patent Application No. 2,763,876, filed on Jan. 11, 2012, the entire contents of which are hereby incorporated by reference.

### BACKGROUND

Grain bags, typically made from plastic, are becoming popular in the agricultural industry for storing grain including wheat, corn, beans, and like agricultural produce. The bags come in packages that are attached to a loading machine which receives grain from a transport vehicle, and pushes the grain into the bag. As the bag fills, the machine moves ahead, such that the grain bag fills and stretches out behind the loading machine. A typical bag will be about nine to twelve feet across, and can be 200 or more feet long.

To unload the bag, a grain bag extractor apparatus is provided that includes feed augers extending laterally right and left along the ground from the input end of an upright oriented main auger. The output end of the main auger is oriented to discharge into a transport vehicle. Such a grain bag extractor apparatus is disclosed for example in U.S. Pat. No. 7,861,851 to the present inventor Dekoning.

Thus to unload a bag, the end of the bag is cut open and the feed augers moved into the open end of the bag. The extractor is connected to a tractor at the front end thereof and the feed augers are at the rear end of the extractor, such that the extractor moves rearward as the grain is collected by the feed augers and raised to the transport vehicle by the main auger. A knife at the top rear of the machine is oriented to slice the top of the bag as the machine moves forward as the grain is removed. In some machines the wheels of the machine pass over the inside of the bag, and in others the bag is taken up on a pinch roller so that grain left on the bag spills rearward and into the bag and is thus saved.

The rearward movement of the extractor may be provided by the tractor drive wheels, or by a roller on the extractor pulling on the bag with the tractor in neutral. Alignment of the extractor with the bag is maintained by steering the tractor. Misalignment can cause damage to the bag, and delay as the extractor is re-oriented with respect to the bag.

### SUMMARY OF THE INVENTION

It is an object of the present invention to provide a grain bag extractor apparatus that overcomes problems in the prior art.

In a first embodiment the present invention provides grain bag extractor apparatus for movement in a rearward operating travel direction into a quantity of grain stored in a bag to extract the grain from the bag and convey the extracted grain into a transport vehicle. The apparatus comprises a frame, with a main auger attached to the frame and having a discharge end oriented to discharge grain into the transport vehicle, and an intake end at a lower rear location with respect to the frame, and at least one feed auger attached to the frame and extending laterally from the intake end of the main auger. Wheels are mounted under the frame to support the apparatus for movement along the ground, a wheel drive is operative to rotate the wheels, and a drive control is operative to activate the wheel drive. A steering mechanism has a steering actuator operative to steer the wheels, and a steering control operative to activate the steering actuator. The drive control and steering control are mounted on a control panel located such that an operator at the control panel has a view of the apparatus moving into the bag.

In a second embodiment the present invention provides a method of extracting grain from a bag and conveying the extracted grain into a transport vehicle. The method comprises providing a grain bag extractor apparatus, the apparatus comprising frame with a main auger attached to the frame and having a discharge end oriented to discharge grain into the transport vehicle, and an intake end of the main auger at a lower rear location with respect to the frame, and at least one feed auger attached to the frame and extending laterally from the intake end of the main auger at a lower rear portion of the frame; mounting wheels under the frame to support the apparatus for movement along the ground, and providing a steering mechanism operative to steer the wheels; positioning an operator at a location with a view of the grain bag extractor apparatus entering the bag, and the operator then manipulating a drive control and driving the wheels in a rearward operating travel direction at a selected speed with a wheel drive such that the at least one feed auger moves into grain exposed at an open end of the bag; wherein the operator further manipulates a steering control to activate a steering actuator to steer the apparatus and maintain alignment of the at least one feed auger and the bag.

Thus the operator can be located with a view of the orientation of the grain bag extractor and grain bag, and steer the extractor so as to avoid damage to the bag. Damage is inconsequential, as same is disposable, but time and grain is wasted cleaning up a mess and reorienting the extractor and bag. The operator can also adjust the speed with which the extractor feed augers advance into the bag, and maintain the augers at maximum capacity while also avoiding excessive speed.

A simple and economical steering system is provided where the steering mechanism comprises an axle member extending transverse to the operating travel direction, and pivotally attached at a middle portion thereof to a lower portion of the frame about a substantially vertical steering axis, and wherein one of the wheels is attached at each end of the axle member, and wherein the steering actuator is operative to pivot the axle member about the steering axis.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic side view f an embodiment of a grain bag extractor apparatus of the present invention;

FIG. 2 is a schematic top view of the lower frame portion of the embodiment of FIG. 1, showing the steering and wheel drive mechanisms; and

FIG. 3 is a schematic top view of the lower frame portion of an alternate embodiment of a grain bag extractor apparatus of the present invention, with a different wheel drive mechanism.

### DETAILED DESCRIPTION OF THE ILLUSTRATED EMBODIMENTS

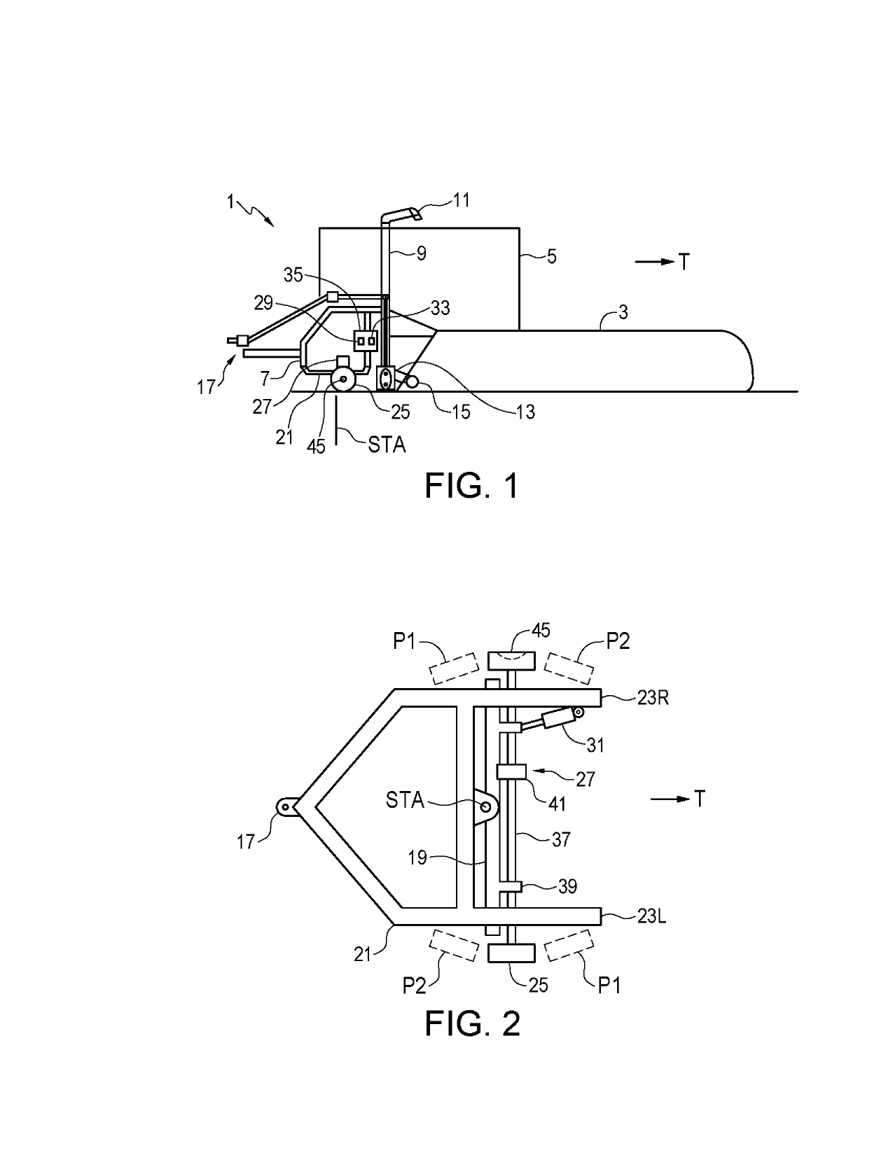

FIG. 1 schematically illustrates an embodiment of a grain bag extractor apparatus 1 of the present invention, for movement in a rearward operating travel direction T into a quantity of grain stored in a bag 3 to extract the grain from the bag 3 and convey the extracted grain into a transport vehicle 5. The apparatus 1 comprises a frame 7, with a main auger 9 attached to the frame 7 and having a discharge end 11 oriented to discharge grain into the transport vehicle 5, and an intake end 13 at a lower rear location with respect to the frame 7. Feed augers 15 are attached to the frame 7 and extend laterally from each side of the intake end 13 of the main auger 9 to gather grain from sides of the bag 3 and bring same to the intake end 13 of the main auger 9 for transfer to the transport vehicle 5. The hitch end 17 is adapted to be attached to a tractor which provides power for the augers, hydraulics, etc. of the apparatus 1. Wheels 25 are mounted under the frame 7 to support the apparatus 1 for movement along the ground.

A steering mechanism is operative to steer the wheels. In the illustrated apparatus 1 the steering mechanism is provided by an axle member 19 extending transverse to the operating travel direction T, and pivotally attached at a middle portion thereof to a lower portion 21 of the frame 7 about a substantially vertical steering axis STA. For increased stability, in the illustrated apparatus 1, right and left outer frame members 23R, 23L rest on outer portions of the axle member 19, and slide on a top surface of the axle member 19 when the axle member 19 pivots about the steering axis STA.

A wheel 25 at each end of the axle member 19 supports the apparatus 1 for movement along the ground, and a wheel drive 27 is operative to rotate the wheels 25. A drive control 29 is operative to activate the wheel drive 27 and to vary a speed and direction of a rotation of the wheels 25. A steering actuator 31 is operative to pivot the axle member 19 about the steering axis STA, and a steering control 33 is operative to activate the steering actuator 31.

In the illustrated apparatus 1, the steering actuator 31 is provided by a hydraulic cylinder attached at one end to the outer frame member 23R and at an opposite end to the axle member 19. The steering actuator 31 is configured such that when the hydraulic cylinder is in the middle of its stroke, the axle member 19 is oriented with the wheels 25 oriented in the operating travel direction T. When the hydraulic cylinder is extended from the middle of its stroke the wheels 25 move to turned position P1, and when the hydraulic cylinder is retracted from the middle of its stroke the wheels 25 move to turned position P2.

For the purposes of the present invention, the steering range does not have to be as wide as for a conventional steered vehicle and the pivoting axle provides a simple and economical steering mechanism.

In a typical apparatus 1 of the present invention, the wheel drive is provided by a hydraulic motor, and the drive and steering controls 29, 33 are hydraulic controls operative to control a flow of hydraulic fluid to the wheel drive 27 and steering actuator 31. The drive control 29 and steering control 33 are mounted on control panel 35 attached to one of right and left side portions of the frame 7. From the control panel 35, the operator can view the advance the of feed augers 15 into the bag 3, and then accordingly manipulate the drive control 29 to vary the speed and direction of a rotation of the wheels 25, and manipulate the steering control 33 to guide the apparatus 1 into the bag 3.

In the illustrated apparatus 1, the wheel drive 27 comprises a drive shaft 37 rotatably attached along a side of the axle member 19 in bearing brackets 39, and a motor 41 mounted on a middle portion of the axle member 19 and is connected by a gear, chain and sprocket, belt and pulley, or a like mechanism to rotate the drive shaft 37. The wheels 25 are attached to outer end of the drive shaft 37.

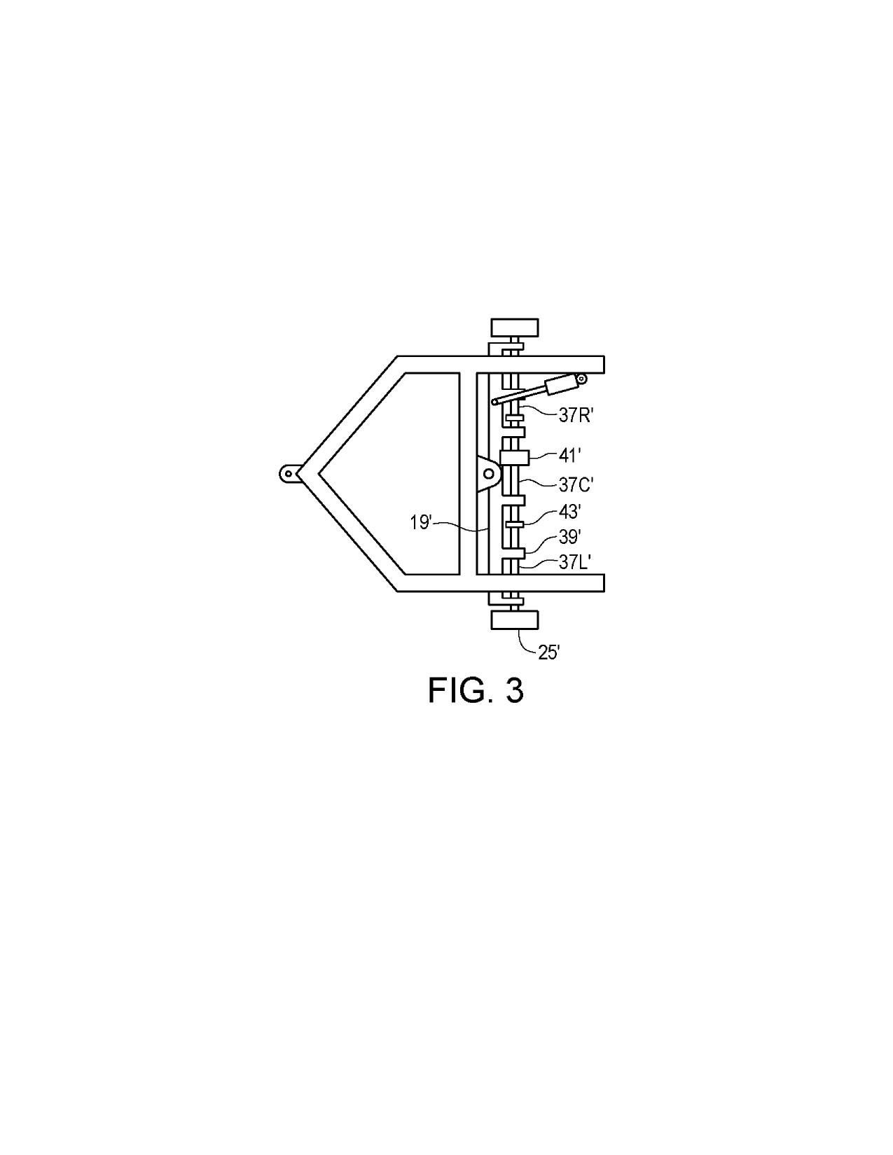

FIG. 3 schematically illustrates a somewhat different wheel drive 27′ where the motor 41′ is again mounted to a middle portion of the axle member 19′, and right, left, and center drive shafts 37R′, 37L′, 37C′ extend along the axle member 19′ rotatably mounted in bearing brackets 39′. The wheels 25′ are attached to outer ends of the corresponding right and left drive shafts 37R′, 37L′, and the motor 41′ rotates the center drive shaft 37C′, which is aligned with the right and left drive shafts 37R′, 37L′ and releasably connected to the right and left drive shafts 37R′, 37L′ through clutches 43′ or some like mechanism.

In order to allow the grain bag extractor apparatus 1 to be towed a transport speeds, the wheel drive 27 can be disengaged from the wheels 25 so the wheels are free to rotate. For example the motor 41 could be disconnected from the wheel drive 27 for transport so the drive shaft 37 and wheels 25 can rotate freely. Also the wheels 25 can be attached to each outer end of the drive shaft 37 by releasable hubs 45, operative in a locked mode to connect the wheels 25 to the drive shaft 37 such that the wheels 25 rotate with the drive shaft 37, and operative in a released mode to disconnect the wheels 25 from the drive shaft 37 such that the wheels 25 rotate independently of the drive shaft 37.

This can also be conveniently accomplished with the drive shaft arrangement of FIG. 3 where the clutches 43′ can be disengaged to allow the wheels 25′ and right and left drive shafts 37R′, 37L′ to rotate freely.

Thus the present invention provides a method of extracting grain from a bag 3 and conveying the extracted grain into a transport vehicle 5. The method comprises providing a grain bag extractor apparatus 1 comprising frame 7 with a main auger 9 attached to the frame 7 and having a discharge end 11 oriented to discharge grain into the transport vehicle 5, and an intake end 13 of the main auger 9 at a lower rear location with respect to the frame 7, and at least one feed auger 15 attached to the frame 7 and extending laterally from the intake end 13 of the main auger 9 at a lower rear portion of the frame 7; mounting wheels 25 under the frame 7 to support the apparatus 1 for movement along the ground, and providing a steering mechanism 19, 31 operative to steer the wheels 25; positioning an operator at a control panel 35 located with a view of the grain bag extractor apparatus 1 entering the bag 3, and the operator then manipulating a drive control 29 and driving the wheels 25 in a rearward operating travel direction T at a selected speed with a wheel drive 27 such that the at least one feed auger 15 moves into grain exposed at an open end of the bag 3; wherein the operator further manipulates a steering control 33 to activate a steering actuator 31 to steer the apparatus 1 and maintain alignment of the at least one feed auger 15 and the bag 3.

The steering mechanism can be provided by pivotally attaching an axle member 19 at a middle portion thereof to a lower portion 21 of the frame 7 about a substantially vertical steering axis STA such that the axle member 19 extends transverse to the operating travel direction T and the frame 7 is supported on the axle member 19, and attaching one of the wheels 25 at each end of the axle member 19. The steering actuator is conveniently a hydraulic cylinder operative to pivot the axle member 19 about the steering axis STA.

With the method and grain bag extractor apparatus 1 of the present invention, the operator can be located adjacent to the feed end of the apparatus and thus be able to view the orientation of the apparatus 1 with respect to the grain bag 3, and maintain the required alignment to avoid damage to the bag, which damage itself is not problematic, but which usually means delays and spilled grain while the proper alignment is regained. The operator can also adjust the speed of progress of the feed augers 15 into the grain to maintain the augers at maximum capacity but while also avoiding excessive speed which can again cause spillage and delay.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A grain bag extractor apparatus for movement in a rearward operating travel direction into a quantity of grain stored in a bag to extract the grain from the bag and convey the extracted grain into a transport vehicle, the apparatus comprising:
a frame, with a main auger attached to the frame and having a discharge end oriented to discharge grain into the transport vehicle, and an intake end at a lower rear location with respect to the frame, and at least one feed auger attached to the frame and extending laterally from the intake end of the main auger;
wheels mounted under the frame to support the apparatus for movement along the ground;
a wheel drive operative to rotate the wheels, and a drive control operative to activate the wheel drive; and
a steering mechanism comprising a steering actuator operative to steer the wheels, and a steering control operative to activate the steering actuator,
wherein the drive control and steering control are mounted on a control panel located such that an operator at the control panel has a view of the apparatus moving into the bag.

2. The apparatus of claim 1 wherein the steering mechanism comprises an axle member extending transverse to the operating travel direction, and pivotally attached at a middle portion thereof to a lower portion of the frame about a substantially vertical steering axis, and wherein one of the wheels is attached at each end of the axle member, and wherein the steering actuator is operative to pivot the axle member about the steering axis.

3. The apparatus of claim 2 wherein the wheel drive comprises at least one drive shaft rotatably attached along a side of the axle member, and a motor operative to rotate the at least one drive shaft, and wherein at least one of the wheels is attached to an outer end of the at least one drive shaft.

4. The apparatus of claim 3 wherein the motor is mounted to a middle portion of the axle member, and wherein right and left drive shafts extend along the axle member and are rotated by the motor, and wherein right and left wheels are attached to outer ends of the corresponding right and left drive shafts.

5. The apparatus of claim 4 wherein the motor rotates a center drive shaft, the center drive shaft substantially aligned with the right and left drive shafts and releasably connected to the right and left drive shafts.

6. The apparatus of claim 3 wherein the wheel drive comprises a drive shaft rotatably attached along a side of the axle member, and a wheel attached to each outer end of the drive shaft, and a motor operative to rotate the drive shaft.

7. The apparatus of claim 6 wherein the motor is releasably connected to rotate the drive shaft.

8. The apparatus of claim 6 wherein the wheels are attached to each outer end of the drive shaft by releasable hubs operative in a locked mode to connect the wheels to the drive shaft such that the wheels rotate with the drive shaft, and operative in a released mode to disconnect the wheels from the drive shaft such that the wheels rotate independently of the drive shaft.

9. The apparatus of claim 2 wherein right and left outer frame members rest on outer portions of the axle member, and wherein the right and left outer frame members slide on a top surface of the axle member when the axle member pivots about the steering axis.

10. The apparatus of claim 1 wherein the steering actuator comprises a hydraulic cylinder attached at one end to the frame at an opposite end to the axle member.

11. The apparatus of claim 1 wherein the control panel is attached to one of right and left side portions of the frame.

12. The apparatus of claim 11 wherein the drive and steering controls are hydraulic controls operative to control a flow of hydraulic fluid to the wheel drive and steering actuator.

13. The apparatus of claim 1 wherein the drive control is operative to vary a speed and direction of a rotation of the wheels.

14. A method of extracting grain from a bag and conveying the extracted grain into a transport vehicle, the method comprising:
providing a grain bag extractor apparatus, the apparatus comprising frame with a main auger attached to the frame and having a discharge end oriented to discharge grain into the transport vehicle, and an intake end of the main auger at a lower rear location with respect to the frame, and at least one feed auger attached to the frame and extending laterally from the intake end of the main auger at a lower rear portion of the frame;
mounting wheels under the frame to support the apparatus for movement along the ground, and providing a steering mechanism operative to steer the wheels; and
positioning an operator at a location with a view of the grain bag extractor apparatus entering the bag, and the operator then manipulating a drive control and driving the wheels in a rearward operating travel direction at a selected speed with a wheel drive such that the at least one feed auger moves into grain exposed at an open end of the bag;
wherein the operator further manipulates a steering control to activate a steering actuator to steer the apparatus and maintain alignment of the at least one feed auger and the bag.

15. The method of claim 14 where in the steering mechanism is provided by pivotally attaching an axle member at a middle portion thereof to a lower portion of the frame about a substantially vertical steering axis such that the axle member extends transverse to the operating travel direction and the frame is supported on the axle member, and attaching one of the wheels at each end of the axle member, and wherein the steering actuator is operative to pivot the axle member about the steering axis.

16. The method of claim 14 wherein the selected speed can be adjusted.

17. The method of claim 14 comprising disconnecting the wheel drive and allowing the wheels to rotate freely when it is desired to move the apparatus to extract grain from another bag.
